(19) United States
(12) Patent Application Publication
(10) Pub. No.: US 2024/0063456 A1
(43) Pub. Date: Feb. 22, 2024

(54) BATTERY PACK CONFIGURED SUCH THAT HEAT TRANSFER BETWEEN BATTERY CELLS IS BLOCKED

(71) Applicant: LG Energy Solution, Ltd., Seoul (KR)

(72) Inventor: Jin Soo Park, Daejeon (KR)

(21) Appl. No.: 18/271,431

(22) PCT Filed: Dec. 15, 2022
(86) PCT No.: PCT/KR2022/020447

§ 371 Date: Jul. 7, 2023

(30) Foreign Application Priority Data
Dec. 15, 2021 (KR) 10-2021-0179442

(51) Int. Cl. H01M 10/613; H01M 10/647; H01M 10/6569; H01M 10/658; H01M 10/6567

(52) U.S. Cl. CPC H01M 10/613; H01M 10/647; H01M 10/6569; H01M 10/658; H01M 10/6567

(57) ABSTRACT

A battery pack including a battery cell stack including a plurality of battery cells, a cooling member configured to cool the battery cell stack, a deformation member configured to discharge heat from the plurality of battery cells to the cooling member, and a housing configured to receive the battery cell stack, the cooling member, and the deformation member therein, wherein the deformation member includes a first deformation member interposed between the plurality of battery cells, and a coolant. It is possible to adjust the temperature of each of the plurality of battery cells to a predetermined level when the temperature of the battery cells is equal to or lower than a dangerous temperature, and it is possible to block heat transfer between the plurality of battery cells when the temperature of the battery cells is higher than the dangerous temperature.

### CROSS-REFERENCE TO RELATED APPLICATIONS

This application is a US national stage of international Application No. PCT/KR2022/020447 filed on Dec. 15, 2022, and claims the benefit of priority to Korean Patent Application No. 2021-0179442 filed on Dec. 15, 2021, the disclosure of which are incorporated herein by reference in their entirety.

### TECHNICAL FIELD

The present invention relates to a battery pack configured such that heat transfer between battery cells is blocked. More particularly, the present invention relates to a battery pack configured such that heat transfer between battery cells is blocked, wherein the battery pack includes a construction capable of preventing heat conduction to a battery cell adjacent thereto when the temperature of a battery cell rises to a dangerous level or higher.

### BACKGROUND

A lithium secondary battery has been used as an energy source for wireless mobile devices, which are small multifunctional products, or wearable devices, which are worn on bodies, and has also been used as an energy source for electric vehicles and hybrid electric vehicles presented as alternatives to existing gasoline and diesel vehicles, which cause air pollution, or an energy storage system (ESS).

As the lithium secondary battery is used as a large-capacity, high-output energy source, as described above, it has become important to secure safety of the lithium secondary battery.

The temperature of the lithium secondary battery increases during charging and discharging thereof, and a high-temperature phenomenon of a battery cell reduces performance of the battery cell. In addition, user safety may become an issue when ignition or explosion occurs due to an increase in temperature of the battery cell. In order to prevent the temperature of the battery cell from increasing to a dangerous temperature at which the battery cell may ignite and explode, or higher, a heat transfer member made of a material that exhibits high thermal conductivity is provided in a battery pack such that thermal energy of the battery cell is discharged through the heat transfer member.

If battery cells are disposed in tight contact with each other to manufacture a battery pack having high energy density, thermal propagation to adjacent battery cells may easily occur instead of thermal energy being discharged through the heat transfer member.

Also, if the heat transfer member functions as a heat transfer path between the battery cells, the speed of thermal propagation between the battery cells may rapidly increase.

When the temperature of a specific battery cell rapidly increases in the state in which a plurality of battery cells are arranged in tight contact with each other, there is a need for technology capable of preventing heat transfer to the other battery cells.

In connection therewith, Patent Document 1 discloses a battery pack configured to have a structure in which a heat transfer plate is added to an outer surface of a battery cell, a heat conduction member is attached to an inner surface of a housing, and one end of the heat transfer plate is capable of contacting the heat conduction member, wherein the shape of a connector of the heat transfer plate that contacts the heat conduction member is changed depending on the temperature of the battery cell. Specifically, the connector is constituted by metal layers having different coefficients of thermal expansion, and the connector is deformed such that, the connector is further bent when the temperature of the battery cell is low, whereby the distance between the connector and the heat conduction member increases, and the distance between the connector and the heat conduction member decreases when the temperature of the battery cell is high. When the temperature of the battery cell increases, therefore, heat conduction through the heat conduction member may be achieved.

As described above, Patent Document 1 has a construction in which a bent insulation plate is disposed at each battery cell and the insulation plate is constituted by metal layers having different coefficients of thermal expansion, whereby heat from the battery cell is transferred to the heat conduction member.

However, Patent Document 1 does not suggest a structure capable of preventing heat conduction between the battery cells.

In Patent Document 2, a filler is provided between a module case and a battery cell and between a plurality of battery cells, and the filler is configured such that the volume of the filler is increased to prevent swelling of the battery cell when the temperature in a battery module is low, and the volume of the filler is decreased to secure a cooling channel between the module case and the battery cell and between the plurality of battery cells when the temperature in the battery module is high.

The filler of Patent Document 2 is made of a shape-changeable material that is deformable depending on temperature. Therefore, when the temperature increases, the filler may contract, whereby the cooling channel may be secured, and therefore the battery cells may be cooled.

In Patent Document 2, however, the expanded filler is disposed between the battery cells, and therefore it is difficult to apply the filler to a battery pack having high energy density.

Therefore, there is a need for technology capable of preventing heat transfer to battery cells adjacent thereto when a thermal runaway phenomenon occurs in a specific battery cell in a battery pack configured such that a plurality of battery cells is arranged in tight contact with each other.

### REFERENCE DOCUMENTS

Japanese Patent Application Publication No. 2018-41582 (2018.03.15)
Korean Patent Application Publication No. 2019-0084775 (2019.07.17)

### SUMMARY

The present invention has been made in view of the above problems, and it is an objective of the present invention to provide a battery pack configured such that a deformation member disposed between a plurality of battery cells arranged in tight contact with each other is deformed when the temperature of the battery cell increases, whereby heat transfer between adjacent battery cells is blocked.

A battery pack according to the present invention to accomplish the above objective includes a battery cell stack including a plurality of battery cells, a cooling member configured to cool the battery cell stack, a deformation member configured to discharge heat from the plurality of battery cells to the cooling member, and a housing configured to receive the battery cell stack, the cooling member, and the deformation member therein, wherein the deformation member includes a first deformation member interposed between the battery cells, and the deformation member includes a coolant therein.

The deformation member may further include a second deformation member disposed between the battery cell stack and the cooling member.

The deformation member may be in a vacuum state in which the remaining part of the deformation member excluding the coolant included therein is an empty space.

Phase transition of the coolant, in which the coolant is evaporated by heat from the battery cell and the coolant is condensed by the cooling member, may occur, and heat transfer from the plurality of battery cells to the cooling member may occur through the phase transition of the coolant.

When temperature of the deformation member reaches a boiling point of the coolant or higher, the deformation member may be deformed such that the volume of the deformation member is expanded, and coolant heat transfer from the plurality of battery cells to the cooling member may be blocked when the entirety of the coolant transitions phase into gas.

A case of the deformation member may be made of a shape-memory alloy.

The phase transition of the coolant may occur between evaporation and condensation depending on the temperature of the battery cell.

The case of the deformation member may include a first surface and a second surface each configured to face the battery cell or the cooling member, each of the first surface and the second surface may be flat at a temperature lower than a deformation temperature of the shape-memory alloy, and each of the first surface and the second surface may be deformed into a curved shape at a temperature higher than the deformation temperature.

When the entirety of the coolant in the deformation member is evaporated into gas as a result of each of the first surface and the second surface being expanded and deformed into a curved shape, heat transfer from the plurality of battery cells to the cooling member may be blocked.

The first deformation member or a thermal insulation member may be disposed between the battery cells.

The thermal insulation member may be made of an elastic material.

The deformation member may be configured to have a flat shape.

The coolant may be selected from the group consisting of ethanol, methanol, and water.

The present invention provides a device including the battery pack as an energy source.

In addition, the present invention may provide various combinations of the above solving means.

As is apparent from the above description, a battery pack according to the present invention includes a deformation member configured to discharge heat from a plurality of battery cells to a cooling member, whereby it is possible to prevent a rapid increase in temperature of the battery cells.

In addition, thermal conductivity of the deformation member is remarkably reduced when the temperature of each of the battery cells increases to a dangerous level, whereby it is possible to block heat transfer between the battery cells.

### BRIEF DESCRIPTION OF DRAWINGS

FIG. 1 is a perspective view of a battery pack according to the present invention.

FIG. 2 is a partial perspective view of a battery pack according to a first embodiment.

FIG. 3 is a sectional view along line A-A′ of FIG. 2.

FIG. 4 is a vertical sectional view of a deformation member before and after deformation.

FIG. 5 is a partial perspective view of a battery pack according to a second embodiment.

### DETAILED DESCRIPTION

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, that a certain element is included does not mean that other elements are excluded, but means that such elements may be further included unless mentioned otherwise.

In addition, a description to embody elements through limitation or addition may be applied to all inventions, unless particularly restricted, and does not limit a specific invention.

Also, in the description of the invention and the claims of the present application, singular forms are intended to include plural forms unless mentioned otherwise.

Also, in the description of the invention and the claims of the present application, “or” includes “and” unless mentioned otherwise. Therefore, “including A or B” means three cases, namely, the case including A, the case including B, and the case including A and B.

Embodiments of the present invention will be described in detail with reference to the accompanying drawings.

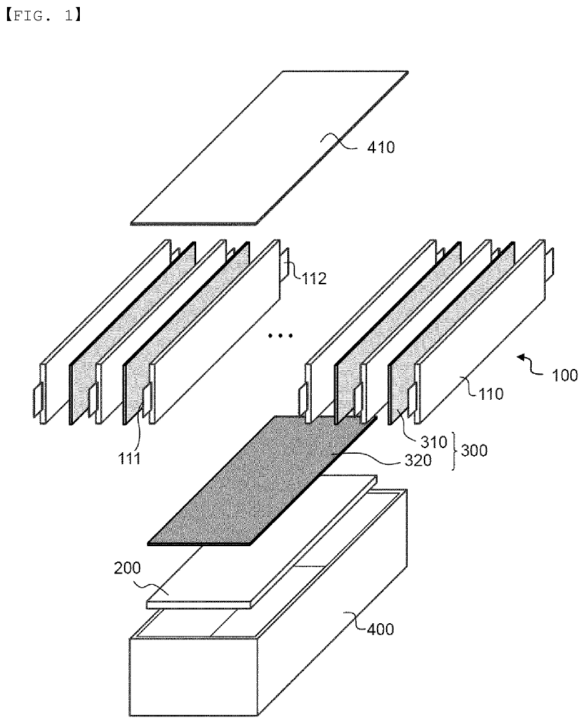

FIG. 1 is a perspective view of a battery pack according to the present invention.

Referring to FIG. 1, the battery pack according to the present invention includes a battery cell stack 100 including a plurality of battery cells 110, a cooling member 200 configured to cool the battery cell stack 100, a deformation member 300 configured to discharge heat from the plurality of battery cells 110 to the cooling member 200, and a housing 400 configured to receive the battery cell stack 100, the cooling member 200, and the deformation member 300 therein, wherein the deformation member 300 includes a first deformation member 310 interposed between one battery cell 110 and another battery cell 110.

In addition, the deformation member 300 includes a second deformation member 320 disposed between the battery cell stack 100 and the cooling member 200.

The deformation member 300 includes a coolant therein, and a case configured to receive the coolant is made of a material that exhibits excellent thermal conductivity. Consequently, cooling of the battery cells and heat transfer between the battery cells are achieved through the deformation member 300; temperature deviation between the battery cells may be prevented through the first deformation member 310, and heat generated from the battery cells 110 may be discharged to the cooling member 200 through the second deformation member 320.

Specifically, the cooling member 200 configured to cool the battery cells 110 is disposed under the battery cell stack 100 including the plurality of battery cells 110, and the second deformation member 320 is disposed between the battery cell stack 100 and the cooling member 200. Consequently, heat from the battery cell stack 100 may be discharged to the cooling member 200 through the second deformation member 320, whereby it is possible to maintain the temperatures of the battery cells 110 within a predetermined range.

The battery cell stack 100, the deformation member 300, and the cooling member 200 may be received in the housing 400, an upper open surface of the housing 400 may be covered with a top plate 410, and the housing 400 may be hermetically sealed, whereby the battery pack may be assembled.

Unlike what is shown in FIG. 1, however, the housing 400 may be formed in the shape of a mono frame configured such that end plates are assembled in directions in which electrode terminals protrude or a U-frame, and a method of hermetically sealing the battery pack may be changed depending on the shape of the housing.

The cooling member 200 may be configured such that the coolant flows in the case, and the cooling member 200 may be provided with an inlet and an outlet, through which the coolant is introduced and discharged, respectively. The coolant may be supplied from the outside of the housing 400, and the coolant may be discharged to the outside of the housing 400.

The battery cell may be a pouch-shaped battery cell configured such that an electrode assembly is received in a pouch-shaped battery case made of a laminate sheet including a metal layer and a resin layer, a prismatic battery cell configured such that an electrode assembly is received in a prismatic metal can, or a cylindrical battery cell configured such that an electrode assembly is received in a cylindrical metal can.

In addition, FIG. 1 shows a bidirectional pouch-shaped battery cell configured such that a positive electrode lead 111 and a negative electrode lead 112 protrude in opposite directions. Unlike this, however, a unidirectional pouch-shaped battery cell configured such that the positive electrode lead 111 and the negative electrode lead 112 protrude in the same direction may be used.

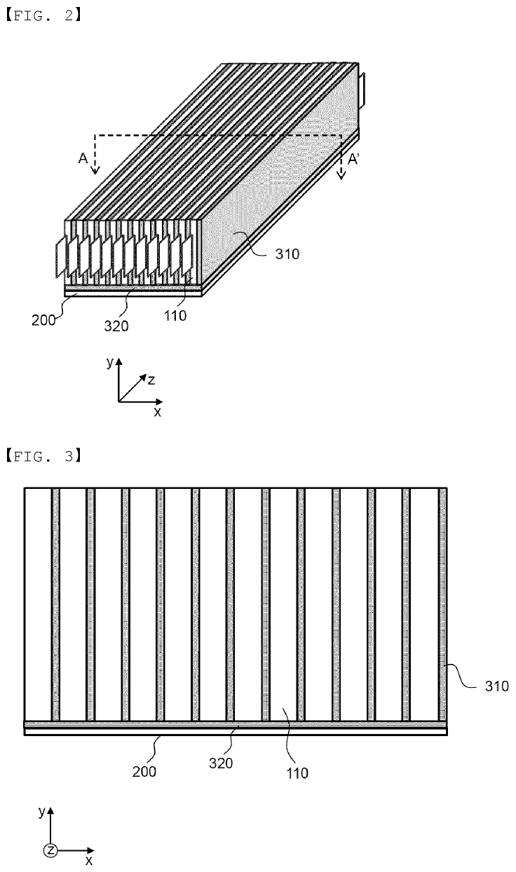

FIG. 2 is a partial perspective view of a battery pack according to a first embodiment, and FIG. 3 is a sectional view along line A-A′ of FIG. 2.

Referring to FIGS. 2 and 3, the state in which the housing is omitted from FIG. 1 is shown.

Each of the first deformation member 310 and the second deformation member 320 is formed in a flat shape.

The y-axis direction length and the z-axis direction length of the first deformation member 310 may be greater than or equal to the y-axis direction length and the z-axis direction length of each of the battery cells 110 corresponding thereto, respectively. Consequently, the contact surface between the battery cells 110 and the first deformation member 310 may be maximized, and therefore quick heat transfer may be achieved.

The x-axis direction length and the z-axis direction length of the second deformation member 320 on which the battery cell stack is disposed may be greater than or equal to the x-axis direction length and the z-axis direction length of a structure in which the battery cells 110 and the second deformation member 320 are disposed in tight contact with each other, respectively. Consequently, the second deformation member 320 has a large heat transfer area between the battery cells 110 and the first deformation member 310 and the cooling member 200.

In a concrete example, on the assumption that the temperature at which a thermal runaway phenomenon may occur due to heat generated from a battery cell is about 150° C., the state in which the temperature of the battery cell is lower than 150° C. may be referred to as a safe temperature range, and the state in which the temperature of the battery cell is equal to or higher than 150° C. may be referred to as a dangerous temperature range. The first deformation member 310 and the second deformation member 320 remain flat and the contact area with the battery cells may be maximized within the safe temperature range, whereby the battery cells may be uniformly cooled, and therefore overheating may be prevented.

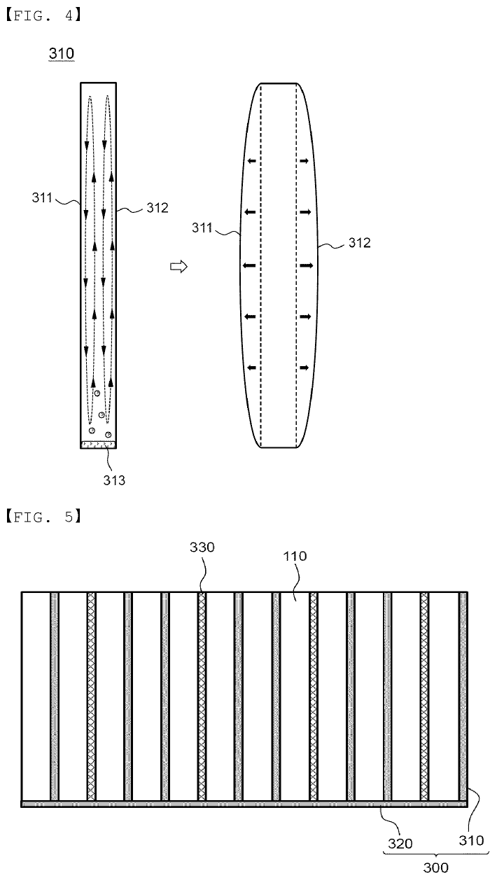

FIG. 4 is a vertical sectional view of the deformation member before and after deformation.

FIG. 4 is a vertical sectional view of the first deformation member 310 constituting the deformation member, and the following description of the first deformation member 310 will be equally applied to the second deformation member 320.

The first deformation member 310 may include a coolant 313 therein, and may be in a vacuum state in which the remaining part of the first deformation member excluding the coolant 313 is an empty space. In the vacuum-state space, the coolant 313 may be evaporated and condensed depending on the temperature of the battery cell. Specifically, phase transition of the coolant occurs, in which the coolant is evaporated by heat from the battery cell and the coolant is condensed by the cooling member 200. As a result of such phase transition of the coolant, heat from the plurality of battery cells 110 may be transferred to the cooling member 200 through the first deformation member 310 and the second deformation member 320.

In FIG. 4, a lower part of the first deformation member 310 having the coolant is disposed to contact the second deformation member 320, and the second deformation member 320 is disposed to contact the cooling member 200. As a result, the temperature of the second deformation member 320 is lower than the temperature of the first deformation member 310.

Consequently, the coolant may be condensed in a lower part of the interior of the first deformation member 310, the temperature of which is relatively low due to contact with the second deformation member, and the coolant may be evaporated in an upper part of the interior of the first deformation member 310, the temperature of which is relatively high.

For example, each of the first deformation member 310 and the second deformation member 320 may be a heat pipe, and any of known heat pipes may be used as the deformation member according to the present invention irrespective of the kind thereof.

In a concrete example, the first deformation member 310 is made of a material that is changeable in shape. When the temperature of the battery cell reaches 150° C. or higher, thus falling within the dangerous temperature range, the first deformation member 310 may be deformed such that the volume of the first deformation member is expanded, as shown in FIG. 4.

That is, when the temperature of the battery cell reaches the boiling point of the coolant 313 or higher, the first deformation member 310 may be deformed such that the volume of the first deformation member is expanded, and when the entirety of the coolant 313 transitions into the gaseous phase, heat transfer from the plurality of battery cells to the cooling member may be blocked.

When the volume of the first deformation member 310 is expanded, as described above, the entirety of the coolant transitions into the gaseous phase due to adiabatic expansion, whereby thermal conductivity is rapidly reduced, and therefore heat exchange between the battery cells and heat exchange between the battery cells and the cooling member may be blocked.

In addition, the contact area with the battery cells is reduced due to volumetric expansion of the first deformation member 310, whereby heat exchange between the battery cells may be further reduced.

In a volumetric expansion method of the deformation member, a case is made of a material that is deformed while being triggered at a specific temperature or higher. Alternatively, a method of connecting a pressurization means, such as a cylinder, to a deformation member made of a material that is expandable and contractible by pressure and applying pressure to the deformation member to expand the volume of the deformation member may be used.

In a concrete example, the case of the deformation member may be made of a shape-memory alloy, and the coolant, phase transition of which is performed such that the coolant is evaporated and condensed depending on the temperature of the battery cell, may be included in the deformation member.

The case includes a first surface 311 and a second surface 312, each of which is formed in the shape of a wide rectangle, configured to face the battery cell or the cooling member. Each of the first surface 311 and the second surface 312 is flat at a temperature lower than the deformation temperature of the shape-memory alloy, and each of the first surface 311 and the second surface 312 is deformed into a curved shape at a temperature higher than the deformation temperature of the shape-memory alloy.

When the entirety of the coolant in the deformation member is evaporated into the gaseous phase as the result of each of the first surface 311 and the second surface 312 being expanded and deformed into a curved shape, as described above, heat transfer between the plurality of battery cells and heat transfer from the plurality of battery cells to the cooling member may be blocked.

The coolant 313 may be selected in consideration of the temperature necessary for expansion deformation. For example, the coolant may be selected from the group consisting of methanol, ethanol, and water.

In the first deformation member 310, the same phase transition as in the second deformation member 320 may also occur in an upward-downward direction.

FIG. 5 is a partial perspective view of a battery pack according to a second embodiment.

Referring to FIG. 5, the state in which a housing and a cooling member are omitted from the battery pack according to the present invention is shown.

A second deformation member 320 is disposed under the plurality of battery cells 110, and a first deformation member 310 or a thermal insulation member 330 is disposed between the plurality of battery cells 110.

That is, any one of the first deformation member 310 and the thermal insulation member 330 is disposed between one battery cell 110 and another battery cell 110, and each of the battery cells contacts the first deformation member 310 on at least one outer surface thereof.

Consequently, it is possible to block heat exchange between neighboring battery cells through the thermal insulation member 330 and to discharge heat from the battery cells to the outside through the deformation members.

Meanwhile, each of the first deformation member and the second deformation member according to the present invention may be made of a material having a volume that is expandable when the temperature of the battery cell increases, and therefore the external shape of a battery cell stack including the battery cells may be enlarged when the volume of each of the deformation members increases. However, it is preferable for the volume of the battery cell stack not to exceed a predetermined space provided in the battery pack, and therefore a thermal insulation member made of an elastic material may be disposed as the thermal insulation member 330 to reduce an increase in volume of the deformation member.

In addition, the description of the first deformation member and the second deformation member described with reference to FIGS. 2 to 4 may be equally applied to the first deformation member and the second deformation member shown in FIG. 5.

The present invention may provide a device including the battery pack according to the present invention as an energy source. For example, the device may be an electric vehicle, a hybrid electric vehicle, a plug-in hybrid electric vehicle, an energy storage system (ESS), an electric cart, or an electric two-wheel vehicle.

Even though the battery pack according to the present invention is applied to a device that requires high capacity and high output, as described above, it is possible to prevent a rapid increase in temperature of the battery cell and to block heat conduction between the battery cells, and therefore it is possible to provide a battery pack with improved safety.

Those skilled in the art to which the present invention pertains will appreciate that various applications and modifications are possible within the category of the present invention based on the above description.

1. A battery pack comprising:
a battery cell stack comprising a plurality of battery cells;
a cooling member configured to cool the battery cell stack;
a deformation member configured to discharge heat from the plurality of battery cells to the cooling member; and
a housing configured to receive the battery cell stack, the cooling member, and the deformation member therein,
wherein the deformation member comprises a first deformation member interposed between the plurality of battery cells, and
wherein the deformation member comprises a coolant therein.

2. The battery pack according to claim 1, wherein the deformation member further comprises a second deformation member disposed between the battery cell stack and the cooling member.

3. The battery pack according to claim 1, wherein the deformation member is in a vacuum state in which a remaining part of the deformation member excluding the coolant included therein is an empty space.

4. The battery pack according to claim 1, wherein:
the coolant undergoes phase transition and is evaporated by heat from the battery cell and condensed by the cooling member, and
heat transfer from the plurality of battery cells to the cooling member occurs through the phase transition of the coolant.

5. The battery pack according to claim 1, wherein:
when temperature of the deformation member reaches a boiling point of the coolant or higher, a volume of the deformation member expands, and
when the entirety of the coolant transitions into a gaseous phase, heat transfer from the plurality of battery cells to the cooling member is blocked.

6. The battery pack according to claim 1, wherein the deformation member comprises a case, and the case is made of a shape-memory alloy.

7. The battery pack according to claim 1, wherein the coolant undergoes a phase transition between evaporation and condensation depending on temperature of each of the plurality of battery cells.

8. The battery pack according to claim 6, wherein:
the case comprises a first surface and a second surface each configured to face the battery cell or the cooling member,
each of the first surface and the second surface is flat at a temperature lower than a deformation temperature of the shape memory alloy, and
each of the first surface and the second surface is deformed into a curved shape at a temperature higher than the deformation temperature.

9. The battery pack according to claim 8, wherein, heat transfer from the plurality of battery cells to the cooling member is blocked when an entirety of the coolant in the deformation member is evaporated into a gaseous state as a result of each of the first surface and the second surface being deformed into the curved shape.

10. The battery pack according to claim 1, wherein the first deformation member or a thermal insulation member is disposed between the plurality of battery cells.

11. The battery pack according to claim 10, wherein the thermal insulation member comprises an elastic material.

12. The battery pack according to claim 1, wherein the deformation member is configured to have a flat shape.

13. The battery pack according to claim 1, wherein the coolant is selected from a group consisting of ethanol, methanol, and water.

14. A device comprising the battery pack according to claim 1 as an energy source.
